(19) United States
(12) Patent Application Publication
(10) Pub. No.: US 2007/0038961 A1
(43) Pub. Date: Feb. 15, 2007

(54) Minimizing indenting

(75) Inventor: Daniel C. Robbins, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/190,712

(22) Filed: Jul. 27, 2005

(51) Int. Cl. G06F 17/00

(52) U.S. Cl. 715/853; 715/514; 715/516

(57) ABSTRACT

A method for providing an array of visual elements, such as a directory tree, that include indented indicators that represent the level of the relationship between the visual elements of the array is disclosed. Visual elements include, but are not limited to, text, images, and/or combinations of text and images. The use of indented indicators enhance the display in a manner that allows the indentation of other parts of the visual elements such as state boxes and text to be reduced to a minimal amount or entirely eliminated.

### BACKGROUND

Users often interact with computing devices via graphical user interfaces. A graphical user interface (GUI) is a computer software program that enables users to view and manipulate visual elements that represent software objects. Certain software objects may also be associated with hardware objects such as disc drives, printers, servers, switches, other peripheral devices, other computing devices, and the like. The visual elements are viewed on a display and manipulated by actions such as moving and clicking a computer mouse, typing on a keyboard, pressing buttons on a keypad, etc.

In a GUI, a visual element may be placed inside of a “window” or a “pane” of a window. A window is a bounded region of a display that is dedicated to presenting a particular software object or set of software objects and/or providing a particular set of functions, i.e., actions. For example, an email program provides a window in which to view email messages represented by visual elements. The email program usually provides functions, i.e., actions, such as, but not limited to, creating, editing, and organizing email messages. The visual elements may, or may not, be placed in panes. A pane is a bounded subregion within a window that is usually dedicated to working with a subset of the software objects and/or functions provided by the containing window. In the example of an email program, there may be separate panes in the email program for viewing a list of directories, viewing a list of email messages, viewing individual email messages etc.

For ease of discussion, the term “window” will be used to refer to bounded regions of a display including panes and the like. Windows are usually rectangular but may be any two dimensional shape. Windows comprise a border, controls placed along one or more of the inside edges of the border, and a viewable area, i.e., a viewport. The viewport of a window occupies the area within the border that is not occupied by the controls.

When the size of the visual content for a window exceeds the size of a viewport of a window, scrolling mechanisms, such as scroll bars and the like, are often inserted along the border of the window usually reducing the size of the viewport. Although scrolling enables the viewing of visual content that would otherwise be obscured, scrolling takes time and effort and, thus can be a distraction that reduces the operational efficiency of a user interface. Scrolling mechanisms often have the disadvantage of occupying part of the display area and reducing the size of the viewport. Another disadvantage of scrolling mechanisms is that users must understand, or learn, how to operate the scrolling mechanisms. Reducing or avoiding scrolling reduces distraction, improves operational efficiency, and may eliminate the need for scrolling mechanisms. Eliminating scrolling mechanisms frees window space, which may then be used to increase viewport area, and simplifies the appearance of windows. Scrolling also requires that users build up a mental model of the content of the scrolled pane. When scrolling is not required, the user can quickly glance at the pane, see the entire contents of the pane, and make judgments about the contents of the pane without having to engage in any interactions.

In situations where the visual content of a window is indented, scrolling is often required if the entire content of the window is to be viewed. A typical example of indented visual content is an indented list of directories and files, i.e., a directory tree. The visual content of a directory tree are the names of the files and directories and the icons that may be next to the names. In order to show that a directory contains one or more files, directories, or both, the icons and names for the contained directories and files are placed below the directory and indented. Often, the combined lengths of a name and icon are less than a viewport width but when the length of indentation is added exceed the viewport width. In the best case, enough of the title of any item is visible to aid in item identification. In the worst case, so much text is past the visible border of the pane that the user can not easily determine the identity of particular indented items. Thus, indentation can cause certain visual elements to become partially or completely obscured, requiring horizontal scrolling. Vertical scrolling may also be required depending on the vertical “length” of the visual content.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Reducing the amount of indentation in an indented array of visual elements by using indicators to represent indentation is disclosed. The visual information lost by reducing the amount of indentation of each visual element is offset by analyzing relationships between related software objects and rendering a relationship indicator for each visual element representing a software object. If desired, the indentation amount can be reduced to zero.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating a contemporary directory tree in a graphical user interface (GUI) of a computing device;

FIG. 2 is a pictorial diagram illustrating a partially hidden exemplary directory tree in a GUI of a computing device;

FIG. 3 is a pictorial diagram illustrating an exemplary directory tree with shading behind the elements of the tree and with reduced indenting of the elements of the tree in the GUI of a computing device;

FIG. 4 is a pictorial diagram illustrating an exemplary directory tree with shading behind the elements of the tree and with no indenting of the elements of the tree in the GUI of a computing device; and

FIG. 5 is a functional flow diagram showing how minimized indenting is applied to an exemplary directory tree.

### DETAILED DESCRIPTION

Embodiments of the invention provide a method and apparatus, including computer-readable medium, for reducing the amount of indentation in an indented array of visual elements. The method involves sequentially determining the containment level of each visual element; determining an indentation location of an indicator for each visual element based on the containment level of the visual element; and rendering each visual element and the indentation indicator associated with the visual element at the determined location. Visual elements include, but are not limited to, text, images, actionable user interface elements (such as buttons), and/or combinations of text and images.

There are a plurality of uses for indentation in the visual content of a viewport. In particular, indentation is a way to show relationships among visual elements such as text and image elements. Relationships represented by indentation include, but are not limited to, containment, relative importance, relative time, and relative size. In a window, software objects may be represented by text, images, or both. While text and/or images representing software objects in a window may be placed in arbitrary locations within the window, often they are placed in more regular arrangements such as rectangular arrays, lists, outlines, trees, and the like. A tree is a data structure containing one or more nodes that are linked together in a hierarchical fashion. Trees are often represented by an indented list of text, actionable user interface elements, and/or images. An exemplary use of indentation in a window's visual content is using indentation to indicate containment in a directory tree.

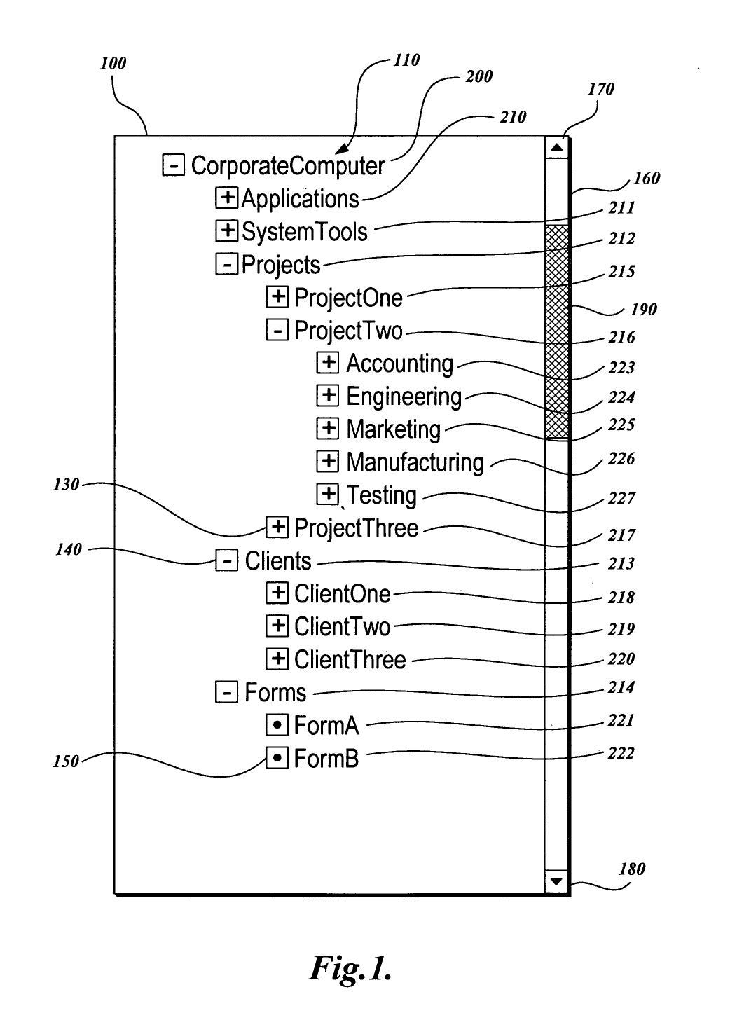

FIG. 1 illustrates an exemplary window 100 displaying a contemporary (prior art) directory tree 110 in the window's viewport. The topmost directory in directory tree 110 is “CorporateComputer” directory 200. Moving from least indented to most indented, the “CorporateComputer” directory is open and contains “Applications,” “SystemTools,” “Projects,” “Clients,” and “Forms” subdirectories 210, 211, 212, 213, and 214. The “Projects” subdirectory 212 contains “ProjectOne,” “ProjectTwo,” and “ProjectThree” subsubdirectories 215, 216, and 217. The “Clients” subdirectory 213 contains “ClientOne,” “ClientTwo,” and “ClientThree” subsubdirectories 218, 219, and 220. The “Forms” subdirectory contains “FormA” and “FormB” files 221 and 222. The “ProjectTwo” subsubdirectory 216 contains “Accounting,” “Engineering,” “Marketing,” “Manufacturing” and “Testing” lower directories 223, 224, 225, 226, and 227. Subdirectories in the top directory are indented and located beneath the top directory. Each subdirectory in the top directory contains lower subdirectories that are indented and located beneath the subdirectory, etc. For example, the “Applications” subdirectory 210 is contained by the “CorporateComputer” directory 200 and, thus, is indented to the right of the “CorporateComputer” directory 200. Also, the “Testing” lower directory 227 is contained by the “ProjectTwo” subsubdirectory 216 that is contained by the “Projects” subdirectory 212 that is, in turn, contained by the “CorporateComputer” directory 200. Thus, the “Testing” lower directory 227 is indented three times to the right.

The window 100 shown in FIG. 1 and described above contains an indented list representing a tree of directories and files stored in a computing device, i.e., the window 100 contains the directory tree 110. The directory tree 110 comprises the directory, subdirectories, etc., and files. As also described above and shown in FIG. 1, a directory, subdirectory, etc. of a directory tree may contain one or more computer files and/or may contain one or more lower order directories. A directory, subdirectory, etc. may also be empty, i.e., contain no files or lower order directories. As shown in FIG. 1, the containment relationship between a directory, subdirectory, etc. and the contents of the directory, subdirectory, etc. i.e., files and/or lower order directories, is often represented by indenting the visual elements that represent the contents of the directory, subdirectory, etc.

As shown in FIG. 1, in addition to labels, each of the directory, subdirectories, etc. of the illustrated, exemplary directory tree 110, is also represented by a box containing a symbol indicating the state of the directory, subdirectories, etc., i.e., a state box. The labels are located to the right of the related state box. For example, in FIG. 1, the “ProjectThree” directory 217 is represented by an actionable user interface element, state box 130, as well as a “ProjectThree” label. The state of a directory, subdirectory, etc., may be open or closed. A plus sign (+) in a state box indicates that a directory, subdirectory, etc., is closed, i.e., not displaying the contents of the directory, subdirectory, etc. For example, the “ProjectThree” subsubdirectory 217 is closed. Thus, the associated state box 130 contains a plus sign. A minus sign (−) in a state box indicates that a directory, subdirectory, etc. is open, i.e., displaying the contents of the directory, subdirectory, etc. For example, the “Clients” subdirectory 213 is open, thus, the associated state box 140 contains a minus sign. A file is represented by a label and a state box containing a dot. For example, the file “FormB” has an associated state box 150 containing a dot.

If a directory, subdirectory, etc., is open, the contents, i.e., files and lower order directories, of the directory, subdirectory, etc., are shown indented and located immediately below the directory, subdirectory, etc. Since directories, subdirectories, etc. may contain other, lower order directories and/or files, the indentation of a lower order directory or file is added to the indentation of the containing directory. If, for example, a directory contains a subdirectory that contains a file, there are two levels of containment. Hence, there are two indentations causing the text and/or images representing the file to be indented two indentation units.

A window may not be large enough to display the text and/or images used to represent a group of software objects. For example, a window may only be large enough to show a limited amount of the contents of a tree. In the vertical dimension of a window, there may be so many elements in a tree that some of the elements cannot be shown. In the horizontal dimension of a window, the text, actionable user interface elements, and/or images used to represent certain software objects may be too wide or too indented to be completely shown. For example, if a directory tree has five levels of containment, five indentations are required. If a viewport is only wide enough to accommodate three indentations, visual elements of the directory tree will be obscured.

To cope with the aforementioned visual element obscuring problem resulting from window size restrictions, windows often provide controls called “scroll bars.” A scroll bar is a control attached to the edge of a window that enables “scrolling” a window's contents, i.e., moving the contents of a window in order to view a particular portion of the contents. In FIG. 1, a scroll bar 160 is shown on the right edge of the window 100. Clicking on the “up” arrow 170 of the scroll bar causes the contents of the window to move up. Clicking on the “down” arrow 180 of the scroll bar causes the contents of the window to move down. The contents of the window may also be moved up or down by moving the “thumb” 190 of the scroll bar. A thumb is an area in the scroll bar that can be clicked and moved to cause the contents of the window to move. Other controls may be used to provide scrolling. Thus, the use of scroll bars to provide scrolling should be construed as exemplary and not limiting.

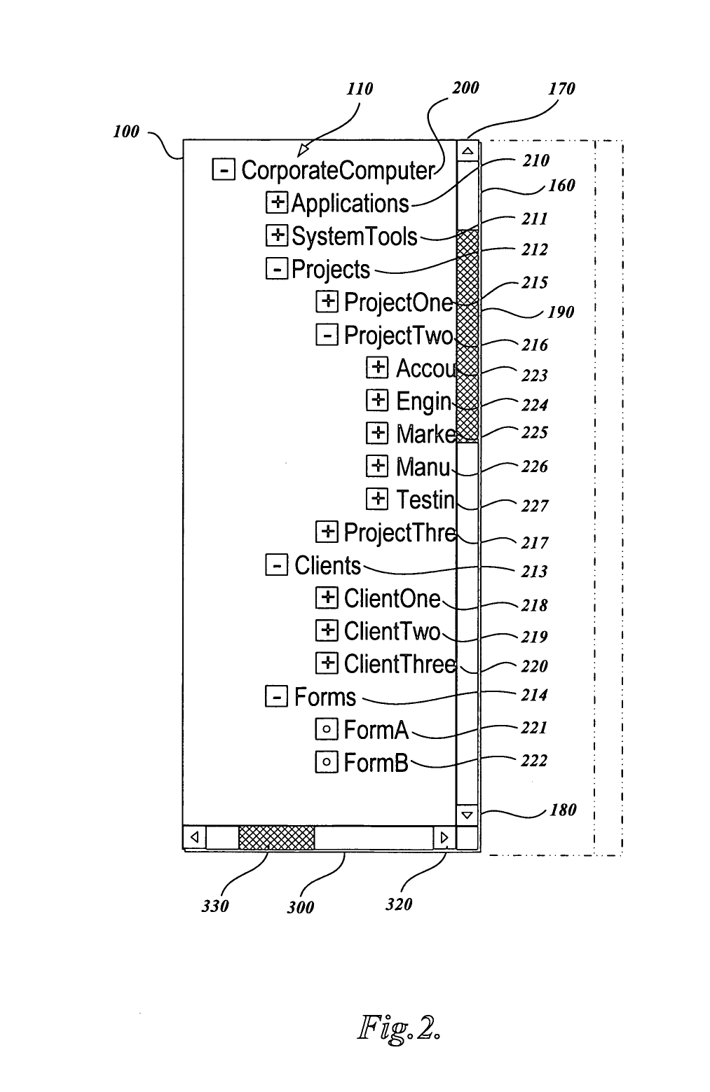

FIG. 2 is another view of window 100 shown in FIG. 1. The view of window 100 in FIG. 1 is the same as the view of window 100 in FIG. 2 except that in FIG. 2, the horizontal dimension of window 100 has been reduced. The “Applications” subdirectory 210 is fully visible. The “Testing” lower directory 227 is not fully visible. The “Testing” lower directory 227 is obscured because the horizontal size of the window has been reduced. Because the horizontal size of the window 100 has been reduced, a horizontal scroll bar 300 has been added to the bottom edge of the window 100. To see the obscured part of window 100, the contents window 100 must be scrolled to the right using the right arrow button 320 of the horizontal scroll bar 300 or by sliding the thumb 330 of the horizontal scroll bar 300 to the right.

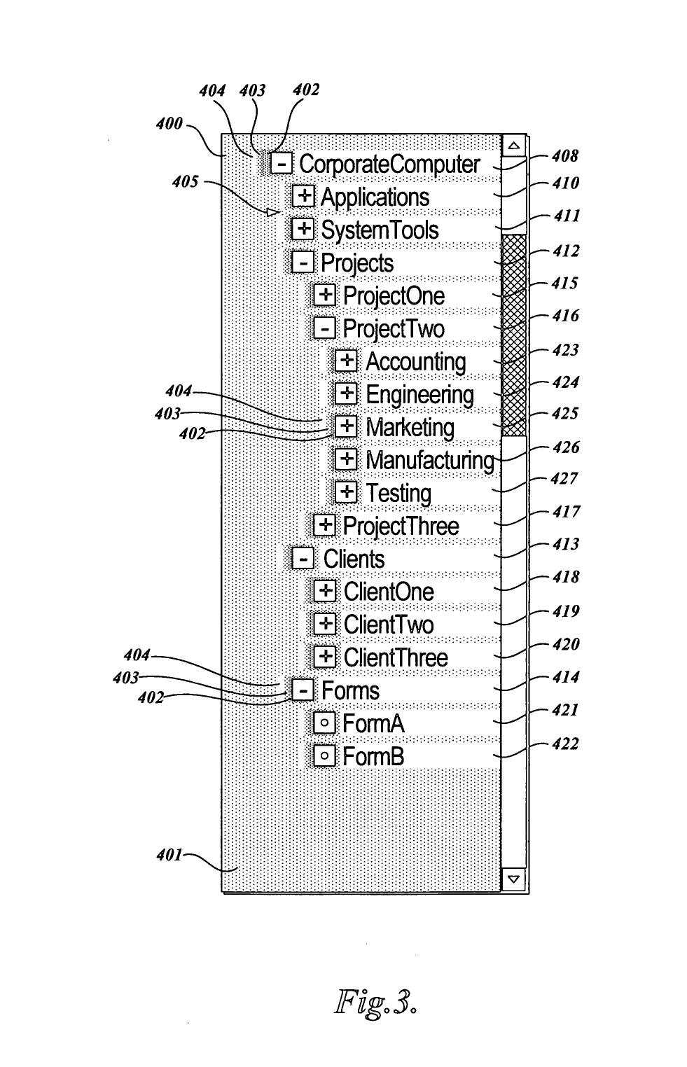

FIG. 3 is a view of a window 400 containing a directory tree 405. The directory tree 405 of FIG. 3 contains visual elements similar to those the directory tree 110 shown in FIGS. 1 and 2. One difference between the directory tree 405 shown in FIG. 3 and the directory tree 110 shown in FIGS. 1 and 2, is that the visual elements of the directory tree 405 shown in FIG. 3 are indented less than the corresponding visual elements in the directory tree 110 shown in FIGS. 1 and 2. The reduction in visual perceptibility caused by the reduction in indentation is offset by the use of background visual cues (in this case shading) in addition to the remaining indentation to denote containment levels. The background shading is represented in FIG. 3 by various stippled textures. More specifically, the illustrated representation includes a light, background stippled texture 401 that is intended to help accentuate the small stippled texture blocks to the left of, and partially surrounding each of the state boxes. More specifically, each of the state boxes is partially surrounded by a heavier stippled texture 402 than the background stippled texture 401. Located to the left of each heavier stippled texture 402 is a medium stippled texture region 403. Located to the left of each of the medium stippled texture regions is a non-stippled region 404. The heavy, medium and non-stippled regions 402, 403 and 404 are designed to highlight the state boxes and, thereby, denote that the associated visual element is indented. The placement of the stippled textures indicates how far to the right the visual element is indented. The directory tree 405 in FIG. 3 uses background shading, i.e., stippled textures, in addition to indentation to enhance the indication of containment levels and clarify the containment relationships. Specifically, the containment level of the “Corporate Computer” directory 408 is identified by a heavy, medium and non-stippled texture block to the left of the associated state block. The containment levels of the “Applications,” “SystemTools,” “Projects,” “Clients,” and “Forms” subdirectories 410, 411, 412, 413, and 414 are identified by heavy, medium and non-stippled texture blocks to the left of their associated state blocks. The containment levels of the “ProjectOne,” “ProjectTwo,” “ProjectThree,” “ClientOne,” “ClientTwo,” “ClientThree,” “FormA,” and “FormB” subsubdirectories and files 415, 416, 417, 418, 419, 420, 421, and 422, are identified by heavy, medium and non-stipple texture blocks to the left of their associated state blocks. Finally, the containment levels of the next lower level directories, i.e., the “Accounting,” “Engineering,” “Marketing,” “Manufacturing,” and “Testing” directories 423, 424, 425, 426, and 427, are identified by heavy, medium and non-stipple texture blocks to the left of their associated state blocks. The use of stippled textures should be construed as exemplary and not limiting. Different colors, different hues of the same color, or other graphical indicia can be used. The chosen indicia should be adequate to clearly indicate which level a directory, subdirectory, etc. or file fits into in the directory tree. Different color hues and/or different colors are ideally suited for providing this visual information, i.e., to help a user quickly differentiate the levels of containment between directories, subdirectories, lower order directories, etc. and files. If desired, different indicia can be used to differentiate files from directories, subdirectories, and lower directories. In a best implementation, these visual cues will not significantly inhibit visibility and readability of text, actionable user interface elements, and images for each element in the represented tree. In addition, these cues can be dynamic in that they may be represented with diminished contrast during normal presentation. When the user moves the cursor over the pane containing the tree, the cues that represent indentation (hierarchy relationships) can be temporarily drawn with higher contrast in order to make them more easily seen.

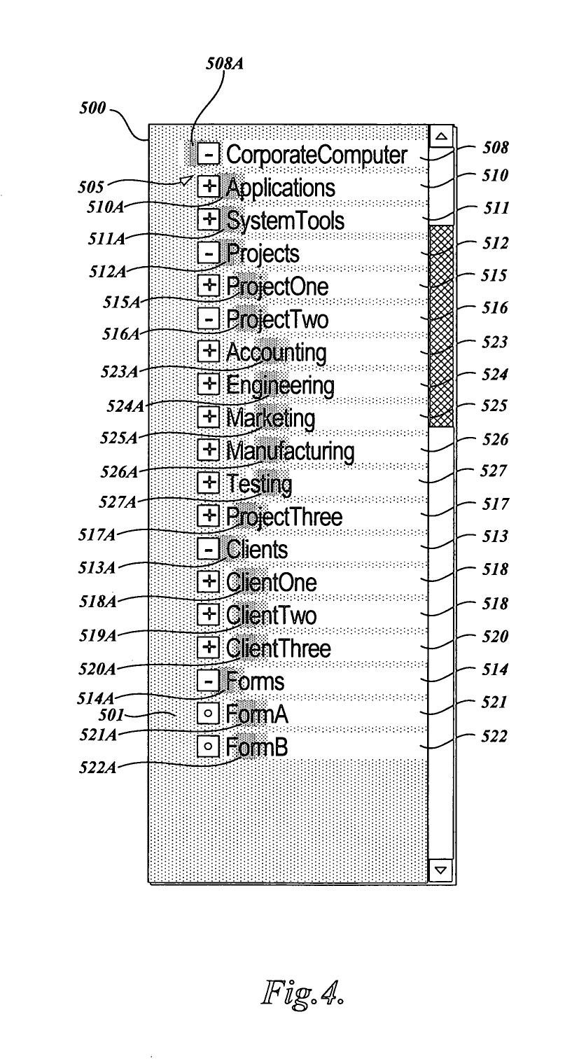

Using stippled texture blocks or some other suitable indicia to indicate the containment relationships between the directory, subdirectories, etc and files in the directory tree allows the amount of indentation to be reduced. As illustrated in FIG. 4, the amount of indentation may even be reduced to zero without loss of the ability to distinguish containment relationships. FIG. 4 is another view of a window 500 and a directory tree 505. The directory tree 505 shown in FIG. 4 contains the same visual elements as the directory tree shown in FIGS. 1, 2 and 3. As in FIG. 3, the window 500 and directory tree 505 shown in FIG. 4 use stippled textures to denote containment levels. That is, like FIG. 3, containment levels are denoted in FIG. 4 by stippled textures; however, in FIG. 4, the amount of indentation has been reduced to zero. Instead of using indentation to denote containment levels, the directory tree 505 in FIG. 4 relies solely on stippled texture to denote containment levels. Specifically, like FIG. 3, the window 500 of FIG. 4 includes light, background stippled texture 501. The containment level of the “Corporate Computer” directory 508 is identified by a heavy, medium, non-stippled texture block 508A to the left of the associated state block also similar to FIG. 3. The containment levels of the “Applications,” “SystemTools,” “Projects,” “Clients,” and “Forms” subdirectories 510, 511, 512, 513 and 514 are identified by heavy, medium and non-stippled texture blocks 510A, 511A, 512A, 513A and 514A a short distance to the right of their associated state blocks. The containment levels of the “ProjectOne,” “ProjectTwo,” “ProjectThree,” “ClientOne,” “ClientTwo,” “ClientThree,” “FormA,” and “FormB” subsubdirectories and files 515, 516, 517, 518, 519, 520, 521 and 522, are identified by heavy, medium, and non-stippled texture blocks 515A, 516A, 517A, 518A, 519A, 520A, 521A, and 522A a greater distance to the right of their associated state blocks. Finally, the containment levels of the next lower level directories, i.e., the “Accounting,” “Engineering,” “Marketing,” “Manufacturing,” and “Testing” directories 523, 524, 525, 526 and 527, are identified by heavy, medium and non-stippled texture blocks 523A, 524A, 525A, 526A and 527A to the right of and spaced farther from their associated state blocks. As with FIG. 3, the use of stippled textures should be construed as exemplary and not limiting. Different colors, different hues of the same color, or other indicia can be used to indicate containment relationships. The chosen indicia and location should be adequate to clearly indicate which level a directory or file fits into. Different color hues and/or different colors are ideally suited for providing the desired visual information in a color display.

In FIGS. 3 and 4, reducing and eliminating indentation allows the labels of the directories and files to be fully exposed and readable, thereby reducing, if not entirely eliminating, the need for scrolling in the horizontal direction. As noted above, adding stippled texture to visual elements to show containment relationships, should be construed as exemplary and not limiting. Grayscale, color, or any other visual effects, including font, textural size, and bolding, known to those skilled in the art may be used to represent relationships such as, but not limited to, containment, importance, etc. In FIG. 4 no indentation is used at all and a stippled texture is the only indication of hierarchy relationships.

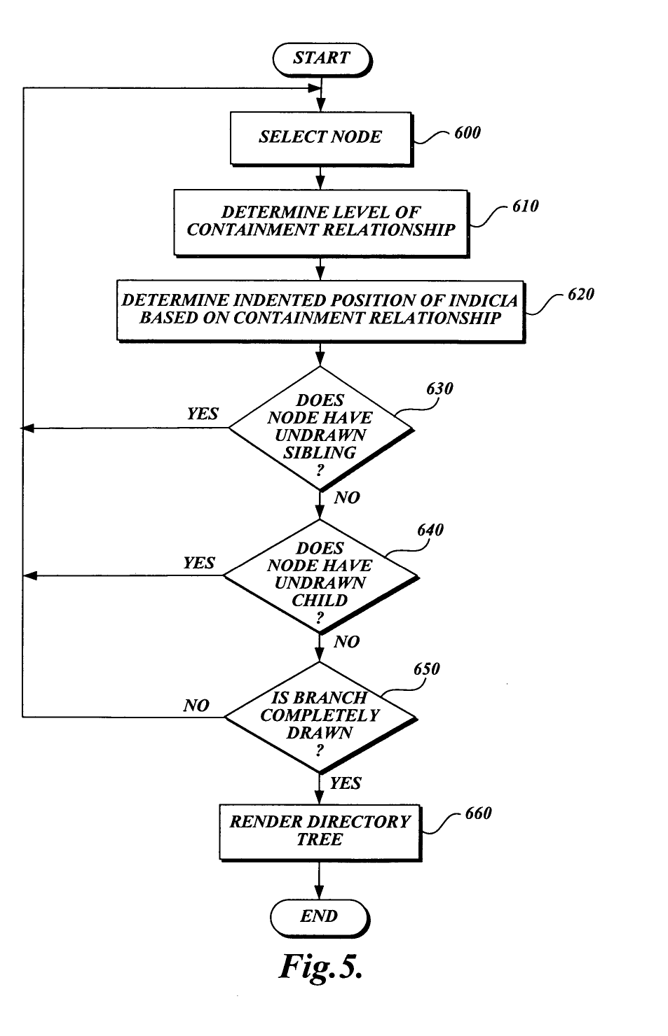

FIG. 5 is a flow diagram showing how background shading is rendered for visual elements that represent nodes in a directory tree. At block 600, a node is selected. If every node in the entire tree is to be visited, the “root” node is selected. Those skilled in the art will appreciate that the root node is the node to which all branches in a tree are connected, either directly or indirectly. If only the nodes in a part of the tree need to be affected, the common node for the branch is selected. At block 610, the level of the containment relationship of the selected node is determined and stippled texture (or other suitable chosen indicia as described above) is rendered at the appropriate indentation to represent the level of containment. At block 620, a visual element representing the node, i.e., a state box and label, is rendered with a reduced (or zero) amount of indentation. At block 630, the selected node is examined to see if the node has an undrawn sibling, i.e., another node in the same branch as the selected node. If the selected node has an undrawn sibling, then the undrawn sibling node becomes the selected node and control flows back through block 600. If the node does not have an undrawn sibling, then the control flows to block 640. At block 640, it is determined if the selected node has an undrawn child, i.e., a node in a branch attached directly to the selected node. If the selected node has an undrawn child node, then the undrawn child node becomes the selected node and control flows back through block 600. If the selected node does not have an undrawn child, then the control flows to block 650. At block 650, a check is made to see if all nodes in the branch have been drawn. If all nodes in the branch have not been drawn, the control flows back through block 600. If the branch has been completely drawn, then the directory tree is rendered at block 660. Then the process ends.

In the process illustrated in FIGS. 3 through 5 and described above, indentation indicators are formed by adding stippled textures or other indicia to the visual elements. Indentation indicators may also be selected from a set of indicators. For example, a program may store a set of “bands” of shading. A band of shading may be selected and applied to the visual element. It is also possible to combine selection and generation by selecting a band of shading and modifying the band to fit a visual element. Other visual cues may be used to indicate indentation without departing from the spirit and scope of the appended claims. For example, as noted above, indentation may be indicated by varying the hue or value of the indentation indicators added to the visual elements.

Although the subject matter has been described in language specific to structural features and/or methodological acts, it is to be understood that the subject matter defined in the depended claims is not necessarily limited to the specific features or acts described above. Rather, the specific features and acts described above are disclosed as example forms of implementing the claims.

The embodiments of the invention in which an exclusive property or privilege is claimed are defined as follows:

1. A method for displaying an array of visual elements comprising:
sequentially determining the containment level of each visual element;
determining an indentation location of an indicator for each visual element based on the containment level of the visual element; and
rendering each visual element and the indicator associated with the visual element, the indicator being rendered at the determined indentation location.

2. The method of claim 1 wherein the visual elements are text elements.

3. The method of claim 1 wherein the visual elements are images.

4. The method of claim 1 wherein the visual elements are a combination of images and text.

5. The method of claim 1 wherein the visual elements form a directory tree.

6. The method of claim 5 wherein the visual elements that form the directory tree include text.

7. The method of claim 6 wherein the text is indented.

8. The method of claim 7 wherein the visual elements include state boxes and wherein the state boxes are also indented.

9. The method of claim 6 wherein the text is not indented.

10. The method of claim 9 wherein the visual elements also include state boxes and wherein the state boxes are also not indented.

11. A computer-readable medium, including computer-executable instructions that, when executed, cause a computing device to:
sequentially determine the containment level of each visual element of a plurality of visual elements;
determine an indentation location of an indicator for each visual element based on the containment level of the visual element; and
render each visual element and the indicator associated with the visual element, the indicator being rendered at the determined indentation location.

12. The computer-readable medium of claim 11 wherein the visual elements are text elements.

13. The computer-readable medium of claim 11 wherein the visual elements are images.

14. The computer-readable medium of claim 11 wherein the visual elements are a combination of images and text.

15. The computer-readable medium of claim 11 wherein the visual elements form a directory tree.

16. The computer-readable medium of claim 15 wherein the visual elements that form the directory tree include text.

17. The computer-readable medium of claim 16 wherein the text is indented.

18. The computer-readable medium of claim 16 wherein the visual elements include state boxes and wherein the state boxes are also indented.

19. The computer-readable medium of claim 16 wherein the text is not indented.

20. The computer-readable medium of claim 19 wherein the visual elements include state boxes and wherein the state boxes are also not indented.
